(19) United States
(12) Patent Application Publication
(10) Pub. No.: US 2015/0112779 A1
(43) Pub. Date: Apr. 23, 2015

(54) APPLICATION OF BENEFITS TO EXISTING CARDS BASED ON CLASSIFICATION IN PREFERRED REWARDS PROGRAM

(71) Applicant: BANK OF AMERICA CORPORATION, Charlotte, NC (US)

(72) Inventors: Gina Schudi, Queen Creek, AZ (US); Eric C. Boyd, New London, PA (US); Tapio J. Makinen, Newark, DE (US); Jerry L. McKinney, Dover, DE (US); Robert Lynn Rowe, Willis Point, TX (US); Mark Saienni, Oswego, IL (US); David A. Stetler, Wilmington, DE (US)

(73) Assignee: BANK OF AMERICA CORPORATION, Charlotte, NC (US)

(21) Appl. No.: 14/056,133

(22) Filed: Oct. 17, 2013

(51) Int. Cl. G06Q 30/02

(52) U.S. Cl. CPC G06Q 30/0215
USPC 705/14.17

(57) ABSTRACT

Embodiments of the invention are directed to apparatus, methods, and computer program products for using a preferred rewards program. In some embodiments, the apparatus is configured to receive information associated with a user's financial institution account on the last day of a current month, wherein the information comprises a monthly asset balance; determine an average asset balance based on generating an average monthly asset balance for at least two months prior to the current month; categorize the user, based on the average asset balance, to determine which of a plurality of status levels is applicable to the user, wherein the plurality of status levels is based on an asset balance range; identify an existing payment card associated with the user; and apply a benefit associated with the categorized status level to the user's existing payment card.

### BACKGROUND

There is a need for a system to provide benefits to users associated with a rewards program.

### BRIEF SUMMARY

The present invention embraces an apparatus to identify financial institution customers based on a checking account balance structure for a preferred rewards program to receive information associated with a user's financial institution account on the last day of a current month, wherein the information comprises a monthly asset balance. In response to receiving the information, the apparatus may then determine an average asset balance based on generating an average monthly asset balance for at least two months prior to the current month. In response to determining the average asset balance, the system may categorize the user, based on the average asset balance, to determine which of a plurality of status levels is applicable to the user, wherein the plurality of status levels is based on an asset balance range. Additionally, the apparatus may identify an existing payment card associated with the user, and apply a benefit associated with the categorized status level to the user's existing payment card.

In some embodiments, the payment card provides a card benefit to the user upon execution of a transaction associated with the card, and wherein the card benefit is provided at least one of prior to, during, immediately after, or a predetermined period after execution of a transaction associated with the card.

In some embodiments, the benefit is provided at least one of prior to, during, immediately after, or a predetermined period after execution of a transaction associated with the card.

In some embodiments, the user is a joint owner of the payment card.

In some embodiments, an apparatus to identify financial institution customers with jointly owned financial institution accounts based on an asset balance structure for a preferred rewards program to receive first information associated with a first user, wherein the first information comprises a monthly asset balance associated with a first user's individually owned financial institution account. In addition, the apparatus is configured to receive second information associated with a second user, wherein the second information comprises a monthly asset balance associated with a second user's individually owned financial institution account. Also, the apparatus is configured to receive third information associated with the first and second users, wherein the third information comprises a monthly asset balance associated with a first and second user's jointly owned financial institution account. In response to receiving the information, the apparatus is configured to determine a first average asset balance associated with the first user based on at least the first information and the third information for at least two months prior to the date of calculation of the first average asset balance. In addition, determine a second average asset balance associated with the second user based on at least the second information and the third information for at least two months prior to the date of calculation of the second average asset balance. In response to determining the first and second average asset balance, the apparatus is configured to categorize the first user based on the first average asset balance, and second user based on the second average asset balance, to determine which of a plurality of status levels is applicable to the first user's financial institution account and which from a plurality of status levels is applicable to the second user's financial institution account, wherein the plurality of status levels is based on an asset balance range and apply one or more benefits associated with the categorized status levels to the first and second user's financial institution account.

In some embodiments, the module is configured to apply one or more benefits based on the status level of the first user, to the first user's individually owned financial institution account.

In some embodiments, the module is configured to apply one or more benefits based on the status level of the second user, to the second user's individually owned financial institution account.

In some embodiments, the module is configured to apply one or more benefits based on the highest status level among the status levels of the first user and the second user, to the first and second user's jointly owned financial institution account.

In some embodiments, the financial institution account is a checking account, a savings account, or an investment account.

In some embodiments, the monthly asset balance is an aggregated sum of one or more of the user's financial institution account balances.

In some embodiments, the module enables a user enrollment into the preferred rewards program.

In some embodiments, the status level is associated with a second benefit.

In some embodiments, the second benefit includes a credit card rewards bonus, a money market savings booster, an investment account reward, a home loan credit, a priority service, banking cost benefits, or one or more additional accounts.

In some embodiments, the apparatus determines a user eligibility based on the average asset balance, wherein the user eligibility comprises an eligibility for categorization of the user's financial institution account into the plurality of status levels.

In some embodiments, the apparatus is further configured to receive the asset balance on the last day of a current month. In response to receiving the asset balance, the apparatus may determine that the user's financial institution account is eligible for an up-tiering based on at least the asset balance, wherein the asset balance is greater than the asset balance required to remain categorized in the first status level, wherein up-tiering comprises changing the category of the user's financial institution account from a first level to a second status level, wherein the asset balance range associated with the second level is greater than the asset balance range associated with the first level. In response to determining the user's eligibility, the apparatus is configured to determine an average asset balance based on generating an average monthly asset balance for at least two months prior to the current month. In response to determining an average asset balance, the apparatus may categorize the user into the second status level based on at least the average asset balance and apply a second benefit associated with the second status level to the user's financial institution account.

In some embodiments, determining that the user's financial institution account is eligible for an up-tiering based on at least the asset balance, wherein the asset balance is within the range of the first status level.

In some embodiments, the apparatus is further configured to receive the asset balance on the last day of a current month, determine that the user's financial institution account is not eligible for an up-tiering based on at least the asset balance and maintain the categorization of the user's financial institution account in the first status level.

In some embodiments, the apparatus is further configured to conduct an annual evaluation of the user's financial account categorization into the first status level.

In some embodiments, the annual evaluation is based on an anniversary month, wherein the anniversary month is associated with the user enrollment into the preferred rewards program.

In some embodiments, the apparatus is further configured to receive the asset balance during the annual evaluation. In response, determine that the asset balance is lower than the asset balance required to be categorized in the first status level and provide the user a grace period from the date of the annual evaluation to deposit additional funds and maintain the asset balance required to remain in the first status level.

In some embodiments, the grace period is at least two months from the date of the annual evaluation.

In some embodiments, the apparatus is configured to send a notification to the user to indicate that the asset balance is lower than the asset balance required to be categorized in the first status level before the annual evaluation.

In some embodiments, the notification may be sent to the user in the form of a text message, a pop up message, or an email.

In some embodiments, the apparatus is further configured to receive the asset balance at the end of the grace period provided. In response, determine an average asset balance based on generating an average monthly asset balance for at least two months prior to the current month. In response to determining an average asset balance, the apparatus may determine that the user's financial institution account is eligible for down-tiering based on the average asset balance, wherein the average asset balance is lower than the asset balance required to remain categorized in the first status level, wherein down-tiering comprises changing the category of the user's financial institution account from a first status level to a third status level based on at least the average asset balance, wherein the asset balance range associated with the third status level is lower than the asset balance range associated with the first status level. In response to determining that the account is eligible for down-tiering, the apparatus may categorize the user into the third status level based on at least the average asset balance and apply a second benefit associated with the third status level to the user's financial institution account.

In some embodiments, the apparatus is further configured to receive the asset balance at the end of the grace period provided. In response, determine an average asset balance by averaging the monthly asset balance for at least two months prior to the date of calculation of the average asset balance, determine that the user's financial institution account is eligible to remain categorized in the first status level based on the average asset balance and maintain the categorization of the user's financial institution account in the first status level.

In some embodiments, a method for identifying financial institution customers based on an asset balance structure for a preferred rewards program is provided, the method comprising: receiving information associated with a user's financial institution account, wherein the information comprises an asset balance; determining an average asset balance based on generating an average monthly asset balance for at least two months prior to the date of calculation of the average asset balance; categorizing the user into a first status level based on at least the average asset balance, wherein the first status level is based on the asset balance range; and applying a benefit associated with the first status level to the user's financial institution account.

In some embodiments, a computer program product for identifying financial institution customers based on an asset balance structure for a preferred rewards program, the computer program product comprising a non-transitory computer-readable medium comprising code causing a first apparatus to: receive information associated with a user's financial institution account, wherein the information comprises an asset balance; determine an average asset balance based on generating an average asset balance for at least two months prior to the date of calculation of the average asset balance; categorize the user into a first status level based on at least the average asset balance, wherein the first status level is based on the asset balance range; and apply a benefit associated with the first status level to the user's financial institution account.

Typically, a user may manage funds in one or more accounts associated with one or more financial institutions. For example, the user may maintain a personal checking account in one financial institution and maintain collection bills in a different financial institution. In some cases, the user may have a savings account at an online only financial institution and a different financial institution for small business or freelancing work. One or more reasons for diversification of funds may include reduced interest rates, avoiding accidental over expenditure, cash back benefits, or the like. In such situations, the preferred rewards program may be used as an incentive to enable the user to aggregate all external funds and maintain them with the financial institution by providing benefits based on the overall asset balance.

### BRIEF DESCRIPTION OF THE FIGURES

Having thus described embodiments of the invention in general terms, reference will now be made to the accompanying drawings, where:

FIG. 1A shows a high level process flow of a system for identifying financial institution customers based on a checking account balance structure for preferred rewards program on a financial institution account level

FIG. 1B shows a high level process flow of a system for identifying financial institution customers based on both an individual account balance structure and a joint account balance structure for preferred rewards program on a user level.

FIG. 2A depicts a first scenario for a preferred rewards categorization applicable to a user's financial institution account.

FIG. 2B depicts a second scenario for a preferred rewards categorization applicable to a user's financial institution account

FIG. 2C depicts a third scenario for a preferred rewards categorization applicable to a user's financial institution account.

FIG. 3 presents an exemplary block diagram of the system environment to implement any process flow described herein.

FIG. 4 depicts a process flow for up-tiering a user's financial institution account status.

FIG. 5 shows a process flow for providing a grace period to the user.

FIG. 6 depicts a process flow for down-tiering a user's financial institution account status.

FIG. 7 presents a process flow for applying benefits to existing cards based on a user's classification in a preferred rewards program.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g. an account holder or a person who has an account (e.g. banking account, credit account, or the like) at the entity). In alternate embodiments, the “user” may be a merchant (e.g. a business, a vendor, a service provider, or the like). The user may also be an agent (customer service representative, internal operations specialist, bank teller, account manager, or the like) associated with the entity.

As used herein, the “mobile device” may be a wide variety of computing devices. In some embodiments, the mobile device may refer to a smart phone, a laptop, a tablet, or the like. In other embodiments, the mobile device may refer to a desktop or rack-mounted computing device.

As used herein, the “asset balance” may be an aggregation of at least one of a deposit amount, investment amount, savings amount, or the like.

As used herein, the “category” may be a status level, a tier level, a ranking, a benefits level, or the like.

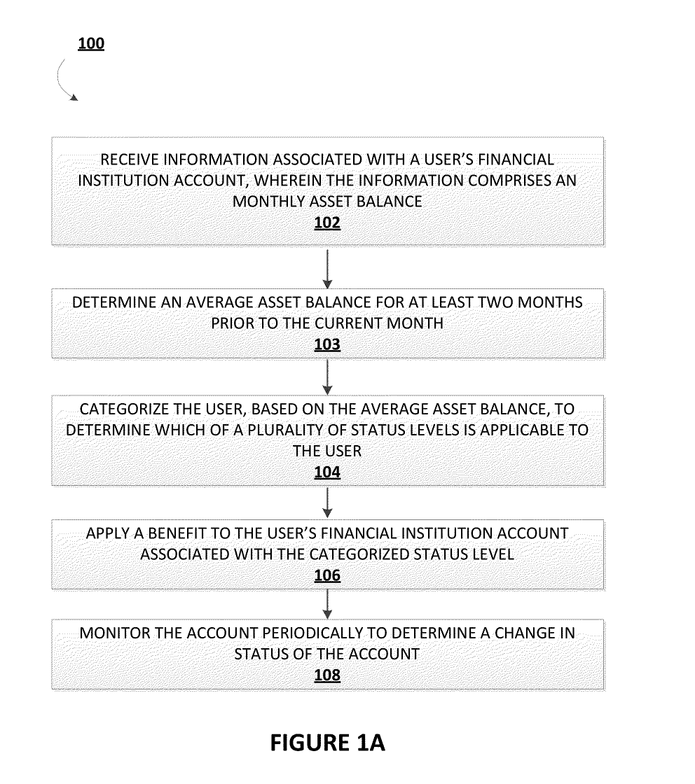

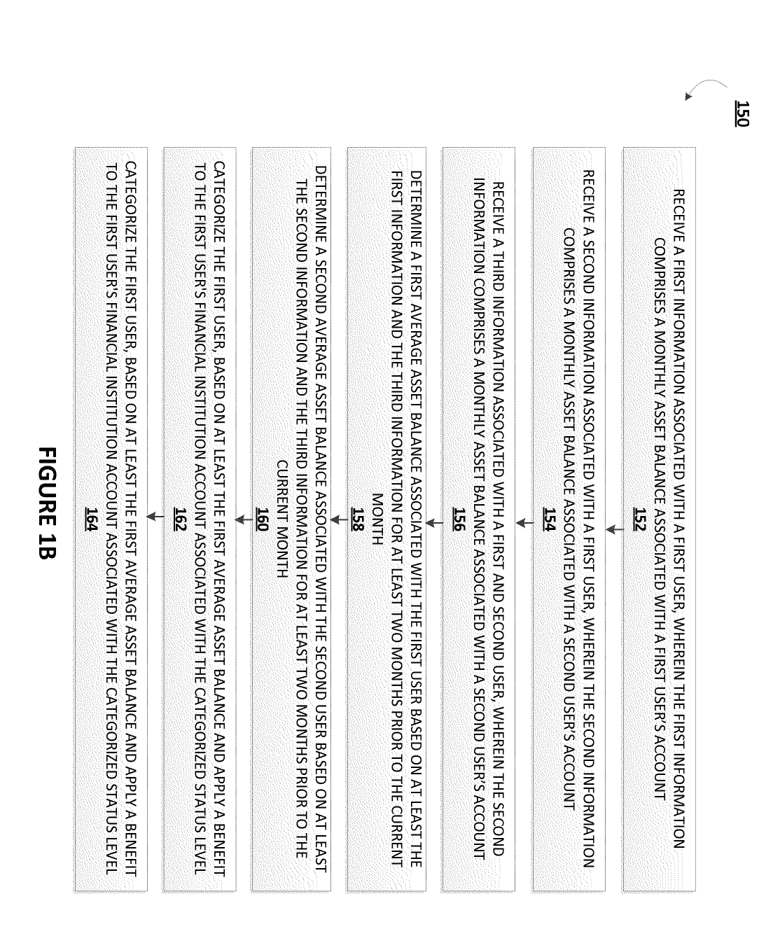

FIG. 1A shows a high level process flow 100 of a system for identifying financial institution customers based on a checking account balance structure for preferred rewards program on a financial institution account level. As shown in block 102, the system may receive information associated with a user's financial institution account. In some embodiments, the user's financial institution account may include a checking account, a savings account, an investment account, or the like. In one aspect, the information received may include an account balance associated with the user's financial institution account. In some embodiments, the information may be an asset balance. For example, the user may have $10,000 in an individual checking account, $30,000 in an investment account, and $5,000 in an individual retirement account, all of which are associated with the financial institution. In such situations, the asset balance associated with user's financial institution account will be $45,000. In some other embodiments, the information may be individual account balances associated with the user's financial institution account.

In response to receiving the information, the system may determine an average asset balance based on generating an average monthly balance for at least two months prior to the date of calculation of the average asset balance, as shown in block 103. In response to determining an average asset balance, the system may then categorize the user, based on the average asset balance, to determine which of a plurality of status levels is applicable to the user, as shown in block 104. For example, if the monthly asset balance associated with the user's financial institution account is between $20,000-$50,000, the user may be categorized into a gold status. In another example, if the monthly asset balance associated with the user's financial institution account is between $50,000-$100,000, the user may be categorized into a platinum status. In yet another example, if the monthly asset balance associated with the user's financial institution account is between $100,000-$250,000, the user may be categorized into a platinum honors status. In yet another example, if the monthly asset balance associated with the user's financial account is greater than $250,000, then the user may be categorized into a platinum plus status with an additional wealth management benefits. In one aspect, categorizing the user's financial institution account may include a user enrollment.

In some embodiments, the system may calculate an average asset balance to determine a user eligibility to enroll in the preferred rewards program. In one aspect, the average asset balance is calculated at the end of every month based on generating an average monthly asset balance for at least two months prior to the current month. For example, the average asset balance calculated at the end of April includes the account balance of the months January, February, and March. In another aspect, the average asset balance calculated at the end of every month based on generating an average monthly asset balance for at least two months including the current month. For example, the average asset balance calculated at the end of April includes the average of the account balance of the months February, March, and April. Typically, the system uses an average asset balance as an eligibility criterion to avoid any false positives/false negatives associated with determining a financial institution account category. For example, a user may receive a bonus check of $25,000 in the month of April and deposit the amount in the financial institution account. If the system checks for user eligibility every month, the chances of categorizing the user into a wrong category may be high because of a single anomaly in the account balance. In another example, the user, in an attempt to receive benefits associated with the platinum plus status, may borrow money from a friend to show an account balance greater than $100,000 just before the monthly review and wrongfully receive the benefits for a whole year. In another example, the user may have maintained a balance of $55,000 every month and receiving platinum status benefits until the user decides to take an extended vacation, thereby causing the account balance to become $35,000 the following month.

In response to categorizing the user's financial institution account, the system may then apply a benefit associated with the category to the user's financial institution account, as shown in block 106. In some embodiments, the pre-defined category may include one or more benefits such as a credit card rewards bonus, a money market savings booster, an investment account reward, a home loan credit, a priority service, banking cost benefits, one or more additional accounts, and the like. In some embodiments, the user may have to enroll or opt-in into the preferred rewards program system to receive benefits associated with each category. In response to applying the benefits, the system may then monitor the user's financial institution account periodically (weekly, monthly, or the like) to determine a change in the status of the account, as shown in block 108.

In one aspect, determining the status of the account may include periodically checking the user's financial institution account to determine if the user has maintained an average asset balance in accordance with the category of the financial institution account. In some embodiments, the user's financial institution account is automatically eligible for an upgrade or “up-tier”. In some other embodiments, the user's financial institution account may be eligible for an upgrade if the user has managed to maintain the average asset balance within the range of the current status level. In alternative embodiments, the user's financial institution account may be eligible for an upgrade if the asset balance associated with the financial institution account is greater than the asset balance range associated with the current status level. Typically, up-tiering may include changing the category of the user's financial institution account from a lower category to a higher category. For example, the user may bring in additional funds to increase the average asset balance from $45,000 to $64,000. In such situations, the system may up-tier the user's status from gold to platinum. In some embodiments, the user may not be able to maintain an average monthly asset balance associated with the categorized status level. In such situations, the system may recommend down-tiering. Typically, down-tiering may include changing the category of the user's financial institution account from a higher category to a lower category.

In some embodiments, the system may conduct an annual evaluation at the end of an annual cycle. Typically, the annual cycle is based on an anniversary month. For example, if the user initially enrolls into the preferred rewards program on Mar. 15, 2013, the user's anniversary month is March and the first annual cycle is between Mar. 31, 2013 and Mar. 31, 2014. In some embodiments, down-tiering may be recommended after an annual evaluation. In one aspect, if the system determines that the user's asset balance is below the range required to remain categorized in the current status, during the annual evaluation, the system may provide the user with a grace period (e.g., 3 months) to increase the asset balance to continue to remain in the same category.

In some embodiments, the system may send one or more notifications before (e.g., 9^{th} month) the annual evaluation date to indicate that the user has an account balance below the required balance to remain in a particular category. In some embodiments, the system may send notifications to the user who is already enrolled in the program, but does not fully take advantage of the benefits. In one aspect, the notification may be sent to the user in the form of a text message, a pop up message, an email, or the like. In some embodiments, the system may down-tier the user's financial institution account if the user voluntarily decides to opt-out. In some other embodiments, the system may down-tier the user's financial institution account if the user closes the one or more financial institution accounts.

In some embodiments, two or more users in a household may be associated with a jointly owned account in addition to individually owned financial institution accounts. Typically, any individual who is a member of the joint account can withdraw from the account and deposit to it. Usually, joint accounts are shared between close relatives or business partners. FIG. 1B shows a high level process flow of a system for identifying financial institution customers based on both an individual account balance structure and a joint account balance structure for preferred rewards program on a user level, 150. As shown in block 152, the system is configured to receive first information associated with a first user on a last day of a current month, wherein the first information comprises a monthly asset balance associated with first user's individually owned financial institution account. In addition, the system is configured to receive second information associated with a second user on the last day of the current month, wherein the second information comprises a monthly asset balance associated with second user's individually owned financial institution account, as shown in block 154. Also, the system is configured to receive third information associated with the first and second users on the last day of the current month, wherein the third information comprises a monthly asset balance associated with the first and second user's jointly owned financial institution account, as shown in block 156. For example, user 1 and user 2 may have a jointly owned financial institution account with an asset balance of $10,000. In addition, user 1 may have an individually owned financial institution account with an asset balance of $48,000, and user 2 may have an individually owned financial institution account with an asset balance of $15,000.

In response to receiving the first, second, and third information, as shown in block 158, the system is configured to determine a first average asset balance associated with the first user based on at least the first information and the third information for at least two months prior to the current month. In addition, as shown in block 160, the system is configured to determine a second average asset balance associated with the second user based on at least the second information and the third information for at least two months prior to the current month. The system may aggregate the asset balance associated with the individually owned accounts and jointly owned accounts and use the aggregated sum to determine an average asset balance.

In response to determining a first and second average asset balance, the system may then categorize the first user, based on at least the first average asset balance, to determine which of a plurality of status levels is applicable to the first user, wherein the plurality of status levels is based on an asset balance range. In response to categorizing the first user, the system may then apply a benefit to the first user's financial institution account associated with the categorized status level, as shown in block 162. In addition, the system may categorize the second user, based on at least the second average asset balance, to determine which of the plurality of status levels is applicable to the second user, wherein the plurality of status levels is based on an asset balance range. In response to categorizing the second user, the system may then apply a benefit to the second user's financial institution account associated with the categorized status level, as shown in block 164. In this scenario, following the previous example, the system may categorize user 1 into a platinum status (joint account: $10,000+individual account: $48,000) and user 2 into a gold status (joint account: $10,000+individual account: $15,000). In such situations, a jointly owned account associated with both user 1 and user 2 will be categorized based on “best of” logic. Accordingly, user 1's individual account will receive benefits associated with a platinum status, user 2's individual account will receive benefits associated with a gold status, and the jointly owned account, owned by both users 1 and 2, will receive benefits associated with a platinum status. In such situations, benefits such as home loan application/accounts will be based on a platinum status if the loan application includes both users 1 and 2 as joint applicants.

In some embodiments, a user who currently receives benefits associated with a particular category may additionally add another user to the program to receive the same benefits for an annual price. In another embodiment, a user who currently receives benefits associated with a particular category may add one or more users with individual financial institution accounts, based on a common membership and/or relationship such as an alumni group, a club association, a family, or the like, for an annual price.

In some embodiments, the co-applicants associated with the jointly owned accounts may have individual cards for spending. In one aspect, each co-applicant may be a primary card holder for their respective cards. For example, user 1 may be a primary card holder for card C1 and user 2 may be a primary card holder for C2. In this scenario, user 1 may be a secondary card holder for C2 and user 2 may be a secondary card holder for C1. In another aspect, one co-applicant may be a primary card holder for both the cards. For example, user 1 is the primary card holder for card C1 and C2. In this scenario, user 2 may be a secondary card holder for both C1 and C2. In some embodiments, the secondary card holder may have a limit on the spending. In one example, user 1 may have a jointly owned checking account with user 2 with a balance of $25,000 and may be a primary card holder of a card C1 associated with the jointly owned checking account. User 2, in addition to the jointly owned checking account, may secondary on card C1, and may be a primary on card C2 associated with the jointly owned checking account. In this scenario, both user 1 and user 2 may be categorized into the gold status and all spending associated with C1 and C2 will be included in the spend calculation at the gold tier level.

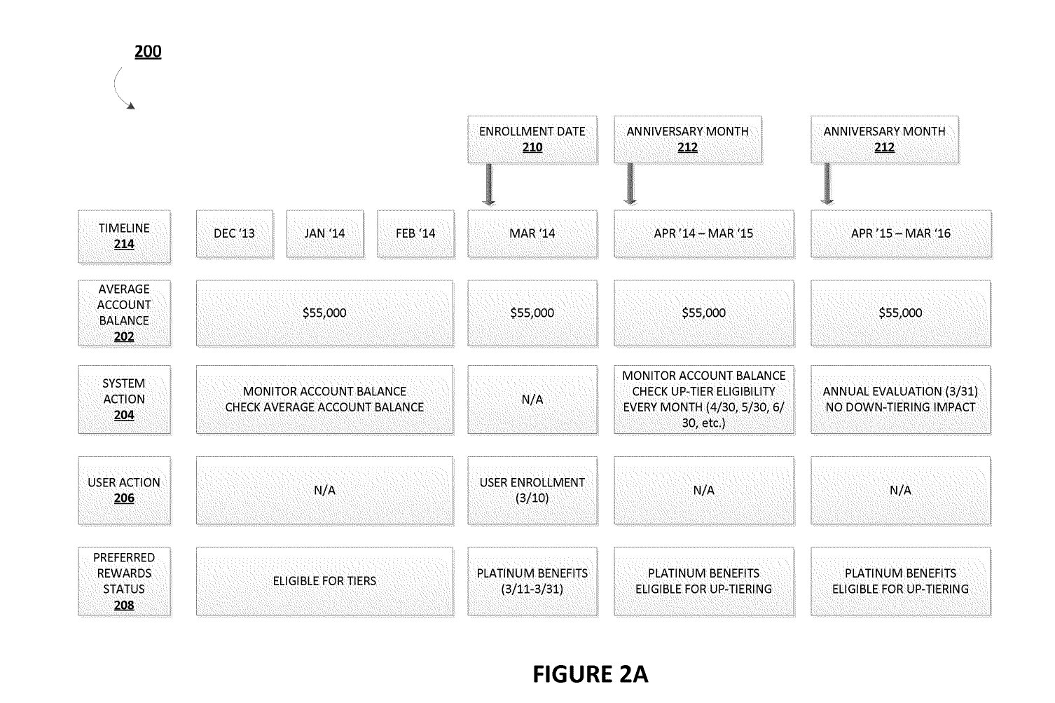

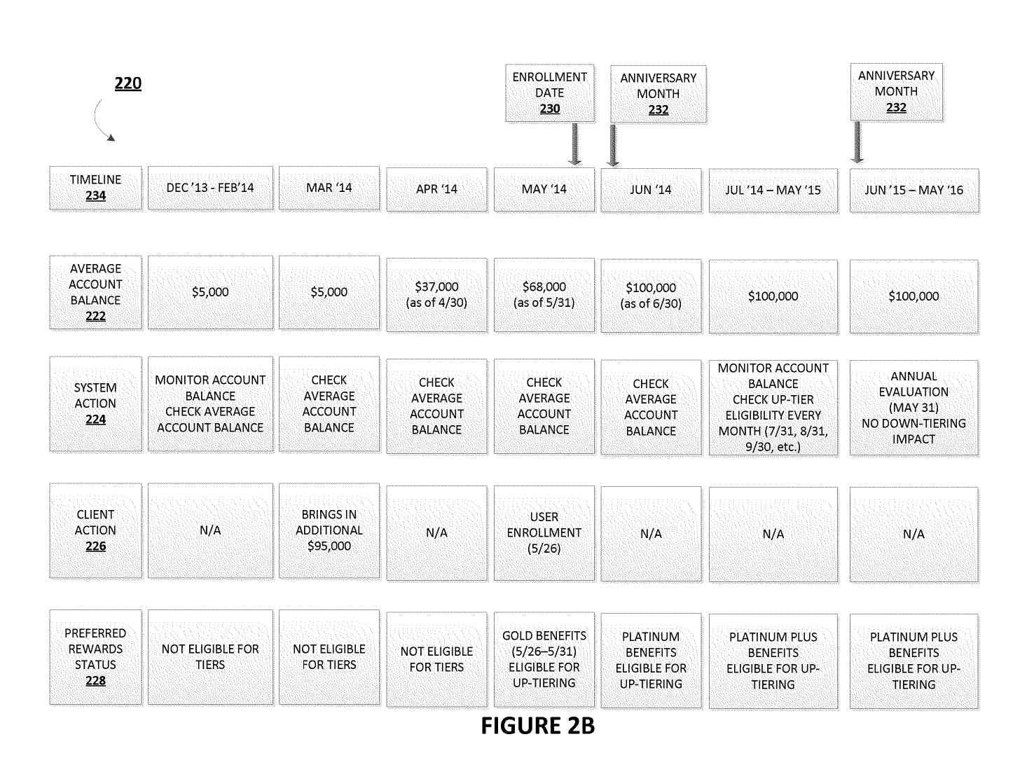

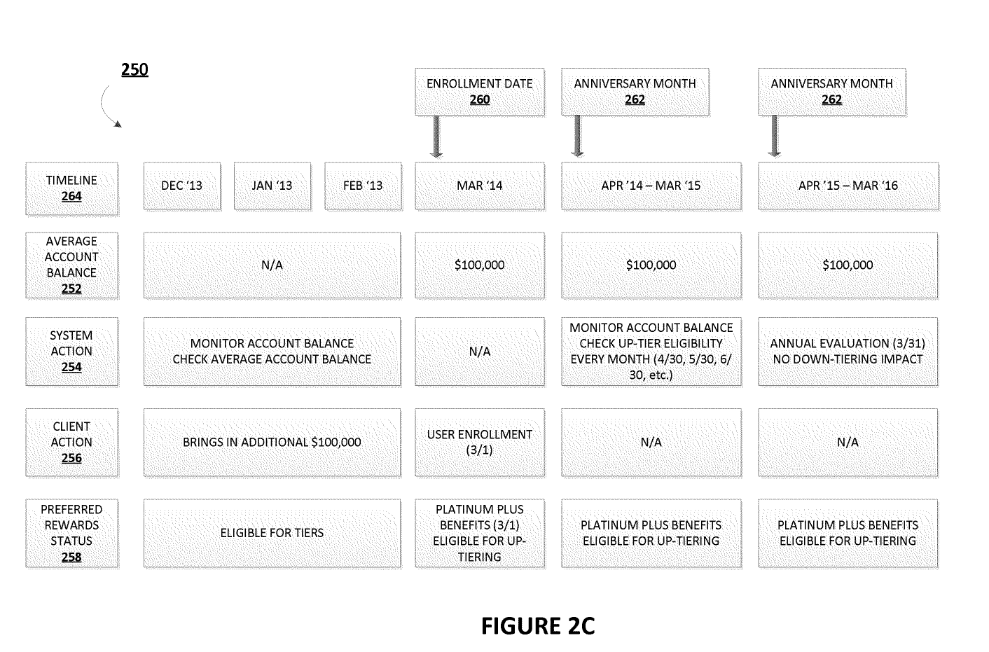

FIG. 2A depicts a first scenario for a preferred rewards categorization applicable to a user's financial institution account (both individually and jointly owned accounts). The first scenario 200 comprises a user's financial institution account with a balance of $55,000 maintained from December '13-March '16. In some embodiments, the first scenario 200 may include, an average account balance 202, a system action 204, a user action 206, a preferred rewards status 208, an enrollment date 210, and an anniversary month 212 for every month listed in the timeline 214.

In some embodiments, the system may monitor the user's financial institution account balance every month. In some other embodiments, the system may determine an average asset balance (December '13 to February '14) to check the user's eligibility to enroll in the preferred rewards program. Once the system determines that the user's financial institution account is eligible for a platinum status, the system enables the user to enroll into the program the following month, in this case, March '14 (say 3/10). The user's financial institution account may receive platinum benefits for the rest of the month in March '14 (3/11-3/31) and the rest of the annual cycle (April '14-March '15). Typically, the system may conduct an annual evaluation based on at least an anniversary month 212. In this case, the anniversary month 212 for the user's financial institution account may be April. During the annual evaluation, the system may analyze the user's financial account status and determine whether or not the user's financial institution account may require down-tiering.

In some embodiments, the user may withdraw funds from the financial institution account causing the asset balance to drop below the asset balance required to remain at the current status level. For example, the user may withdraw funds resulting in an average asset balance of $5,000 at the end of December '13 (say), and may continue to maintain an asset balance of $5,000 through the remainder of the annual period. In such situations, the system may provide a grace period to the user as a reminder to increase the asset balance to maintain the categorization of the financial institution account in the same status level. If the user continues to maintain the asset balance at $5,000 even after the end of the grace period, the system may down-tier the user's financial institution account and remove any status associated with the user's financial institution account. If the user manages to bring in additional funds to replenish the asset balance to say $50,000, the system may maintain the user's financial institution account status as platinum. If the user manages to bring in additional funds enough to replenish the asset balance to say $25,000, the system may down-tier the user to a gold status. In some embodiments, the user may bring in additional funds to replenish the asset balance after the grace period is over. In such situations, the system may down-tier the user first, and depending on the average asset balance, may reinstate the status. In some embodiments, the user's financial institution account may not receive benefits associated with a status during the time period between down-tiering and up-tiering of the user's status level.

FIG. 2B depicts a second scenario 220 for a preferred rewards categorization applicable to a user's financial institution account (both individually and jointly owned accounts). The second scenario 220 comprises a user's financial institution account with an insufficient account balance ($5,000) to be eligible for a tier status initially and then brings in additional funds ($95,000) to become eligible for a tier status. In some embodiments, the second scenario 220 may include, an average account balance 222, a system action 224, a user action 226, a preferred rewards status 228, an enrollment date 230, and an anniversary month 232 for every month listed in the timeline 234 (December '14-May '16).

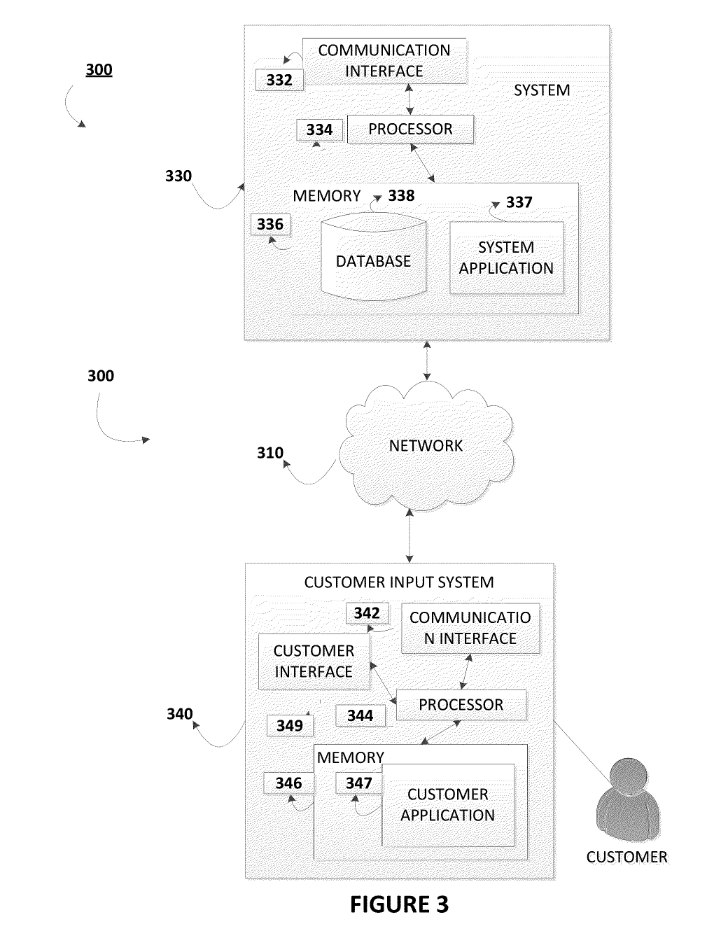

In some embodiments, the system may monitor the user's financial institution account balance every month. In some other embodiments, the system may determine an average asset balance (December '13 to February '14) to check the user's eligibility for the preferred rewards program. As shown in FIG. 3B, the user's average asset balance during the period, December '13-February '14 ($5,000), is not eligible for tiers at the end of March '14. However, the following month, the user may bring in an additional $95,000 in the month of March '14. In response to the additional $95,000 brought in by the user, the system may determine that the average 3 month monthly asset balance (January '14, February '14 and March '14) at the end of April '14 during the monthly review on 4/30 has increased from $5,000 to $37,000. In response to determining that the average monthly asset balance is eligible to be associated with a preferred reward category, the system may enable the user to enroll in the program. Assuming that the user enrolls in the program on 5/26, the user's financial institution account may receive benefits associated with the gold status for the rest of the month (5/26-5/31). During the monthly review of the user's financial institution account at the end of May '14, the system may determine that the user's average monthly asset balance has increased from $37,000 to $68,000 (calculated for months February '14, March '14, and April '14), and determine that the user is eligible for up-tiering to a platinum plus status. In response to determining that the user's financial institution account is eligible for up-tiering, the system may enable the user to enroll in the platinum plus status beginning July '14. Typically, the system may conduct an annual evaluation based on at least an anniversary month 232. In this case, the anniversary month 232 for the user's financial institution account may be July. During the annual evaluation, the system may analyze the user's financial account status and determine whether or not the user's financial institution account status may require down-tiering.

FIG. 2C depicts a third scenario 250 for a preferred rewards categorization applicable to a user's financial institution account (both individually and jointly owned accounts). The third scenario comprises user who is a new applicant for a financial institution account. In some embodiments, the financial institution account may include one or more new applicants. In such situations, the financial institution account, if categorized into the preferred rewards program, will enable the co-applicants to receive the appropriate benefits associated with the jointly owned financial institution account. In some embodiments, the second scenario 250 may include, an average account balance 252, a system action 254, a user action 256, a preferred rewards status 258, an enrollment date 260, and an anniversary month 262 for every month listed in the timeline 264 (December '14-May '16).

In this scenario, the user may apply for a financial institution account in December '14. The system may monitor the account balance every month and calculate the average monthly asset balance (December '13 to February '14) at the end of March '14 during the monthly review to determine that the user's financial institution account is eligible to receive platinum plus benefits. In response to determining that the user's financial institution account is eligible to receive benefits, the system may enable the user to enroll into the preferred rewards program. Assuming that the user enrolls in the program on 3/1, the user may receive platinum plus benefits the rest of the month (from 3/1 to 3/31). In one aspect, the system may monitor the account balance to check up-tier eligibility every month after user enrollment (4/30, 5/30, 6/30, or the like). Typically, the system may conduct an annual evaluation based on at least an anniversary month 262. In this case, the anniversary month 262 for the user's financial institution account may be April. During the annual evaluation, the system may analyze the user's financial account status and determine whether or not the user's financial institution account status may require down-tiering.

FIG. 3 presents an exemplary block diagram of the system environment 300 for implementing the process flows described herein in accordance with embodiments of the present invention. As illustrated, the system environment 300 includes a network 310, a system 330, and a customer input system 340. Also shown in FIG. 3 is a customer of the customer input system 340. The customer input system 340 may be a mobile device or other non-mobile computing device. The customer may be a person who uses the customer input system 340 to execute a customer application 347. The customer application 347 may be an application to communicate with the system 330, perform a transaction, input information onto a customer interface presented on the customer input system 340, or the like. The customer application 347 and/or the system application 337 may incorporate one or more parts of any process flow described herein.

As shown in FIG. 3, the system 330, and the customer input system 340 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 may be secure and/or unsecure and may also include wireless and/or wired and/or optical interconnection technology.

The customer input system 340 may include any computerized apparatus that can be configured to perform any one or more of the functions of the customer input system 340 described and/or contemplated herein. For example, the customer may use the customer input system 340 to transmit and/or receive information or commands to and from the system 330. In some embodiments, for example, the customer input system 340 may include a personal computer system (e.g. a non-mobile or non-portable computing system, or the like), a mobile computing device, a personal digital assistant, a mobile phone, a tablet computing device, a network device, and/or the like. As illustrated in FIG. 3, in accordance with some embodiments of the present invention, the customer input system 340 includes a communication interface 342, a processor 344, a memory 346 having an customer application 347 stored therein, and a customer interface 349. In such embodiments, the communication interface 342 is operatively and selectively connected to the processor 344, which is operatively and selectively connected to the customer interface 349 and the memory 346. In some embodiments, the customer may use the customer application 347 to execute processes described with respect to the process flows described herein. Specifically, the customer application 347 executes the process flows described herein.

Each communication interface described herein, including the communication interface 342, generally includes hardware, and, in some instances, software, that enables the customer input system 340, to transport, send, receive, and/or otherwise communicate information to and/or from the communication interface of one or more other systems on the network 310. For example, the communication interface 342 of the customer input system 340 may include a wireless transceiver, modem, server, electrical connection, and/or other electronic device that operatively connects the customer input system 340 to another system such as the system 330. The wireless transceiver may include a radio circuit to enable wireless transmission and reception of information. Additionally, the customer input system 340 may include a positioning system. The positioning system (e.g. a global positioning system (GPS), a network address (IP address) positioning system, a positioning system based on the nearest cell tower location, or the like) may enable at least the customer input system 340 or an external server or computing device in communication with the customer input system 340 to determine the location (e.g. location coordinates) of the customer input system 340.

Each processor described herein, including the processor 344, generally includes circuitry for implementing the audio, visual, and/or logic functions of the customer input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the customer application 347 of the memory 346 of the customer input system 340.

Each memory device described herein, including the memory 346 for storing the customer application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the customer application 347. In some embodiments, the customer application 347 includes an interface for communicating with, navigating, controlling, configuring, and/or using the customer input system 340. In some embodiments, the customer application 347 includes computer-executable program code portions for instructing the processor 344 to perform one or more of the functions of the customer application 347 described and/or contemplated herein. In some embodiments, the customer application 347 may include and/or use one or more network and/or system communication protocols.

Also shown in FIG. 3 is the customer interface 349. In some embodiments, the customer interface 349 includes one or more output devices, such as a display and/or speaker, for presenting information to the customer. In some embodiments, the customer interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the customer. In some embodiments, the customer interface 349 includes the input and display devices of a mobile device, which are operable to receive and display information.

FIG. 3 also illustrates a system 330, in accordance with an embodiment of the present invention. The system 330 may refer to the “apparatus” described herein. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. Therefore, the system 330 may be a server managed by the entity. The system 330 may be located at the facility associated with the entity or remotely from the facility associated with the entity. In some embodiments, such as the one illustrated in FIG. 3, the system 330 includes a communication interface 332, a processor 334, and a memory 336, which includes a system application 337 and a structured database 338 stored therein. As shown, the communication interface 332 is operatively and selectively connected to the processor 334, which is operatively and selectively connected to the memory 336.

It will be understood that the system application 337 may be configured to implement any one or more portions of the various customer interfaces and/or process flow described herein. The system application 337 may interact with the customer application 347. It will also be understood that, in some embodiments, the memory includes other applications. It will also be understood that, in some embodiments, the system application 337 is configured to communicate with the structured database 338, the customer input system 340, or the like.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the structured database 338. As used herein, the structured database 338 may be one or more distinct and/or remote databases. In some embodiments, the structured database 338 is not located within the system and is instead located remotely from the system. In some embodiments, the structured database 338 stores information or data described herein.

It will be understood that the structured database 338 may include any one or more storage devices, including, but not limited to, datastores, databases, and/or any of the other storage devices typically associated with a computer system. It will also be understood that the structured database 338 may store information in any known way, such as, for example, by using one or more computer codes and/or languages, alphanumeric character strings, data sets, figures, tables, charts, links, documents, and/or the like. Further, in some embodiments, the structured database 338 may include information associated with one or more applications, such as, for example, the system application 337. It will also be understood that, in some embodiments, the structured database 338 provides a substantially real-time representation of the information stored therein, so that, for example, when the processor 334 accesses the structured database 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. It will also be understood that the system 330 may include and/or implement any embodiment of the present invention described and/or contemplated herein. For example, in some embodiments, the system 330 is configured to implement any one or more of the embodiments of the process flows described and/or contemplated herein in connection any process flow described herein. Additionally, the system 330 or the customer input system 340 is configured to initiate presentation of any of the customer interfaces described herein.

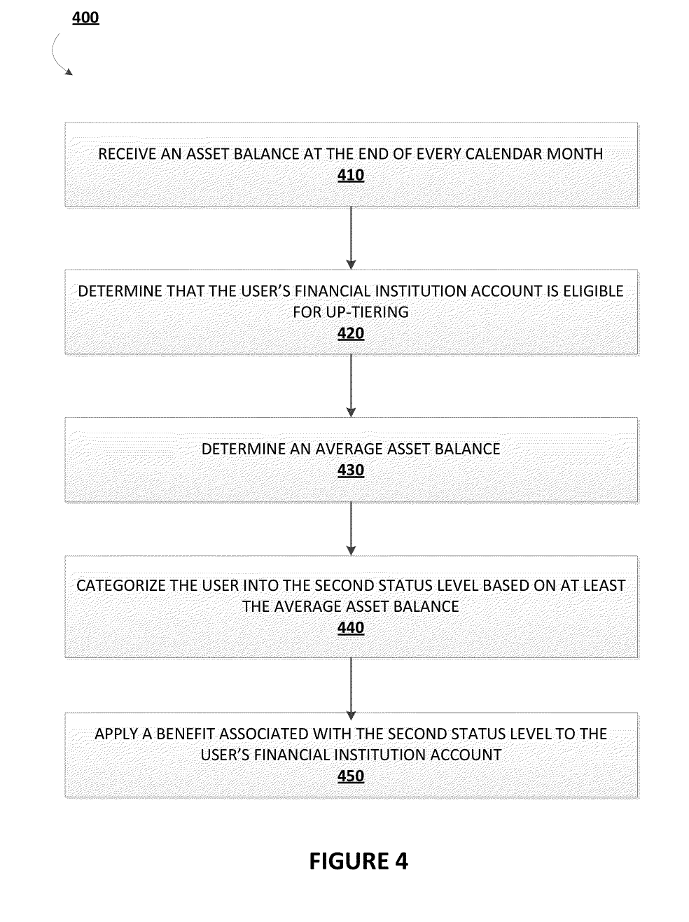

FIG. 4 depicts a process flow for up-tiering a user's financial institution account status 400. In some embodiments, the system is configured to receive an asset balance on the last day of a current month, as shown in block 410. In response to receiving the asset balance, the system may determine that the user's financial institution account is eligible for up-tiering, as shown in block 420. In some embodiments, the asset balance may be greater than the asset balance required to remain categorized in the first status level. In some embodiments, up-tiering may include changing the category of the user's financial institution account from a first status level to a second status level, wherein the asset balance range associated with the second status level is greater than the asset balance range associated with the first status level. For example, the system may have categorized the user in the gold status based on an asset balance of $40,000 in February. The user may have brought in additional funds in March to increase the asset balance to $60,000. In response, on 3/31, the system may determine that the user is now eligible for up-tiering into a platinum status. In one aspect, the system may determine that the user has maintained an asset balance to remain within the categorized status level. In such situations, the system may continue to apply benefits associated with the current status level to the user's financial institution account.

In response to determining that the user's financial institution account is eligible for up-tiering, the system may then determine an average asset balance, as shown in block 430. In one aspect, the system may receive an asset balance associated with the user's financial institution account periodically (e.g., end of every calendar month). The system may calculate an average asset balance based on the asset balance received at least two months prior to the date of calculation of the average asset balance. In some embodiments, the system may calculate an average asset balance on the last day of a current month. In some embodiments, the system may determine that the average asset balance is greater than the asset balance required to be categorized in the first level, and may categorize the user into a second status level, as shown in block 440. Continuing with the previous example, when the system determines that the user's financial institution account is greater than first status level (in this case gold status) and falls within the asset balance range of the second status level (in this case platinum status), the system may change the status level of the user's financial institution account into platinum status. In response to changing the status level, the system may apply a benefit associated with the second status level to the user's financial institution account, as shown in block 450.

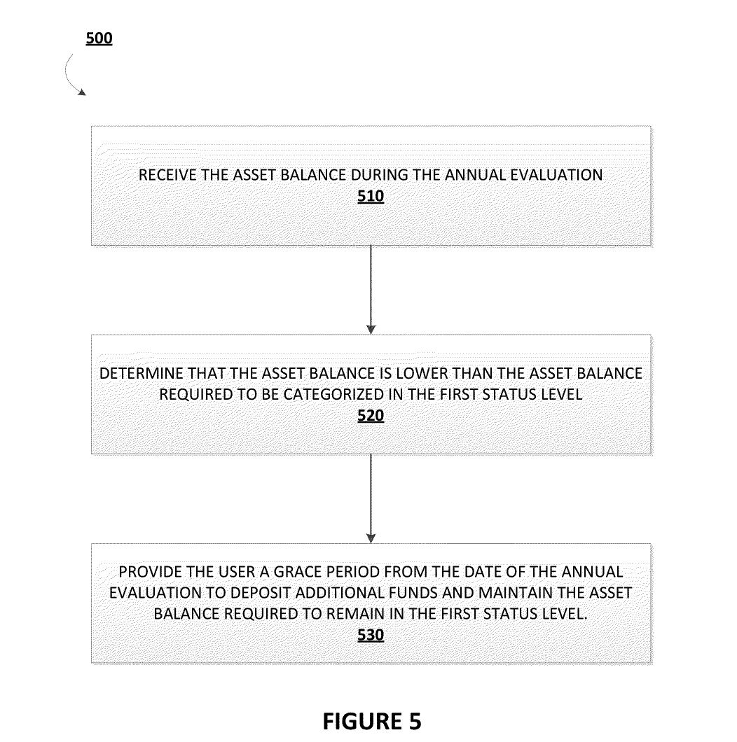

FIG. 5 shows a process flow for providing a grace period to the user 500. In some embodiments, the system may receive the asset balance during an annual evaluation of user's financial institution account, as shown in block 510. In some embodiments, the system may conduct an annual evaluation on the anniversary month associated with a user enrollment into the preferred rewards program. In one aspect, the anniversary month may be the month immediately after the user enrollment. In another aspect, the anniversary month may be the first month that the user's financial institution account receives one or more benefits associated with a category/status level. In response to receiving the asset balance, the system may then determine that the asset balance is lower than asset balance required to be categorized in the first status level, as shown in block 520. For example, the system may determine that the user's financial account has an asset balance of $12,000, but is categorized in the gold status. In such situations, the system may provide the user a grace period from the date of the annual evaluation to deposit additional funds and maintain the asset balance required to remain in the first status level, as shown in block 530. In some embodiments, the grace period may be at least two months from the date of the annual evaluation. In some other embodiments, the grace period may be based on the number of months taken into consideration when calculating the average asset balance. In one aspect, the system may receive an asset balance associated with the user's financial institution account periodically (e.g., end of every calendar month). The system may calculate an average asset balance based on the asset balance received at least two months prior to the date of calculation of the average asset balance.

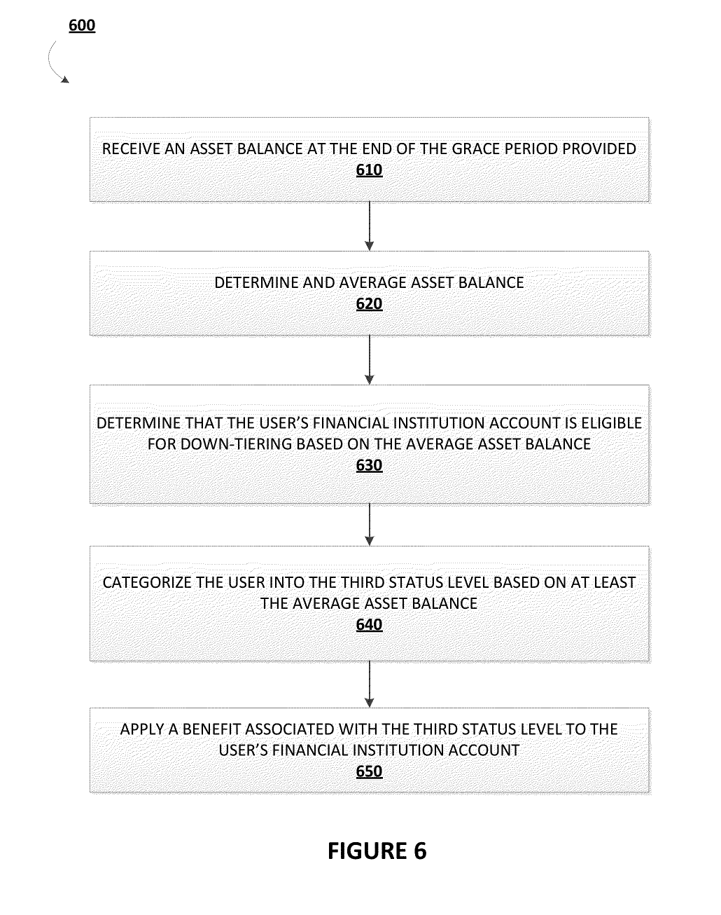

FIG. 6 shows a process flow for down-tiering a user's financial institution account. In one aspect, the system may receive an asset balance from the user's financial institution account at the end of the grace period provided, as shown in block 610. In response to receiving the asset balance, the system may then determine an average asset balance, as shown in block 620. In response to determining the average asset balance, the system may determine that the user's financial institution account is eligible for down-tiering, as shown in block 630. In some embodiments, if the user manages to bring the average asset balance within the asset balance range associated with the categorized status level, the system may continue to apply benefits associated with the status level to the user's financial institution account. In some embodiments, down-tiering may include changing the category of the user's financial institution account from a first status level to a third status level, wherein the asset balance range associated with the third status level is lesser than the asset balance range associated with the first status level. For example, the system may have categorized the user in the platinum status based on an asset balance of $60,000 in February. During the annual evaluation, the user's asset balance may have dropped to $30,000. In response, the system may provide the user with a grace period of 3 months to bring the average asset balance back to the first status range. At the end of the grace period, if the user's asset balance is still not back up to within the platinum status range ($50,000-$100,000), the system may determine that the user is eligible for down-tiering.

In response to determining that the user is eligible for down-tiering, the system may then categorize the user into the third status level (in this case, gold status), as shown in block 640. In response to categorizing the account, the system may then apply one or more benefits associated with the third status level to the user's financial institution account, as shown in block 650.

In some embodiments, the invention described herein may be able to identify existing payment cards (e.g., credit cards, debit cards, or the like) that a user may have and extend bonuses or rewards to the user based on the user's categorization (or status level) in the rewards program described herein. For example, a user may have an existing credit card associated with a financial institution. The existing credit card may provide benefits to the user based on types of transactions executed using the card (e.g., credit transaction, debit transactions, gas purchase transactions, groceries purchase transactions, or the like) and the volume of transactions executed using the card. For example, a benefit (e.g., a card benefit) provided to the user is 10% bonus points on a qualifying transaction that has been executed using the card. The 10% bonus points may be provided at the point of transaction or may be provided a predetermined period after execution of the transaction.

Based on embodiments of the invention described herein, additional benefits are provided to the user based on the user's categorization (or status) in the rewards program described herein. For example, the additional benefit on the qualifying transaction may be additional 5% bonus points on top of the 10% bonus points. The additional 5% bonus points may be provided at the point of transaction or a predetermined period after execution of the transaction. Furthermore, the additional benefit may be a more valuable benefit if the user of the card is categorized in a higher tier. For example, if the user is categorized in a higher tier, the additional benefit may be an additional 7% bonus points rather than an additional 5% bonus points. The additional benefits are provided either prior to, during, immediately after, or a predetermined period after executing transactions using the card. Therefore, users with existing cards receive additional benefits as described herein without opening or enrolling in new cards or card programs. Although the additional benefit described herein is in the form of bonus points, the additional benefit may also be in the form of a cash bonus. For example, the user may redeem bonus points (e.g., 10,000 bonus points) for $500 cash, and may also receive 25% bonus points on top of the $500 cash redemption.

In some embodiments, the card may be jointly owned by a first user and a second user. In such embodiments, the additional benefit provided to an owner of the card (either the first user or the second user) is based on the highest status level between the status levels of the first user and the second user. For example, if the first user has a higher status level than the second user, a transaction executed by the second user is eligible for an additional benefit (on top of the card benefit) associated with the first user's status level. Furthermore, the additional benefit is not provided to an authorized user of the card who is not a joint owner of the card. Therefore, the invention described herein provides a reward to a user based on both the identity of the user using the card and the categorization (or status level) of the user (or a joint user) in the rewards program described herein. The provision of the additional benefit is subject to up-tiering and down-tiering processes as described with respect to the rewards program described herein.

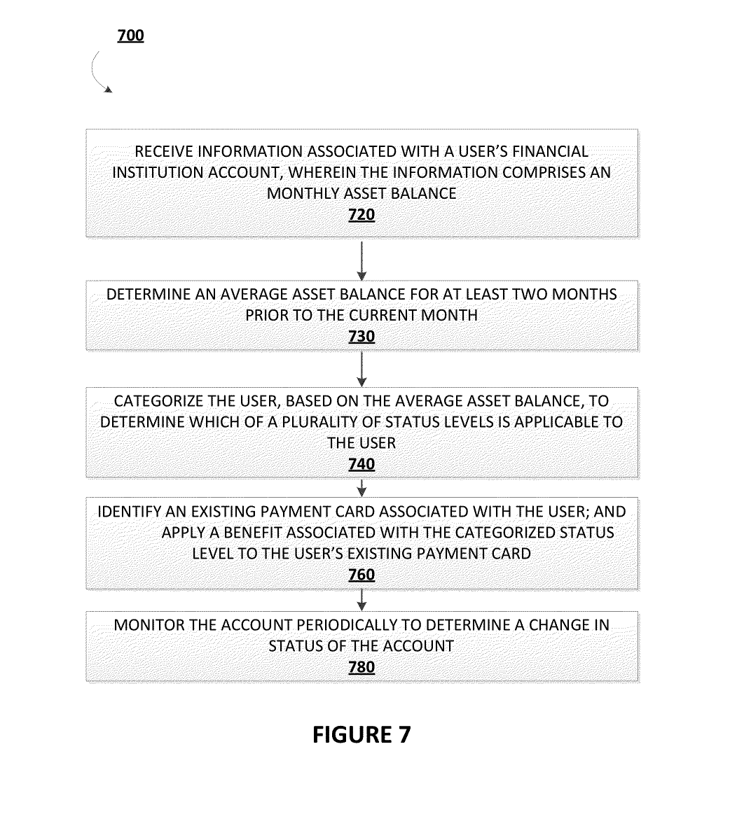

Referring now to FIG. 7, FIG. 7 illustrates a process flow similar to the process flow described in FIG. 1A. Steps 720, 730, 740, and 780 are similar to steps 102, 103, 104, and 108, respectively, in FIG. 1A. Step 760 in FIG. 7 is different from step 106 in FIG. 1. As described in step 760, the apparatus described herein identifies an existing payment card associated with a user and applies a benefit based on the user's status level to transactions executed using the payment card. The benefit may be applied at least one of prior to, during, immediately after, or a predetermined period after execution of a transaction using the payment card.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, COBOL, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus to identify financial institution customers based on an asset balance structure for a preferred rewards program, the apparatus comprising:
a memory;
a processor; and
a module stored in memory executable by a processor, and configured to:
receive information associated with a user's financial institution account on the last day of a current month, wherein the information comprises a monthly asset balance;
determine an average asset balance based on generating an average monthly asset balance for at least two months prior to the current month;
categorize the user, based on the average asset balance, to determine which of a plurality of status levels is applicable to the user, wherein the plurality of status levels is based on an asset balance range;
identify an existing payment card associated with the user; and
apply a benefit associated with the categorized status level to the user's existing payment card.

2. The apparatus of claim 1, wherein the payment card provides a card benefit to the user upon execution of a transaction associated with the card, and wherein the card benefit is provided at least one of prior to, during, immediately after, or a predetermined period after execution of a transaction associated with the card.

3. The apparatus of claim 1, wherein the benefit is provided at least one of prior to, during, immediately after, or a predetermined period after execution of a transaction associated with the card.

4. The apparatus of claim 1, wherein the user is a joint owner of the payment card.

5. The apparatus of claim 1, wherein the financial institution account is a checking account, a savings account, or an investment account.

6. The apparatus of claim 1, wherein the monthly asset balance is an aggregated sum of one or more of the user's financial institution account balances.

7. The apparatus of claim 1, wherein the module enables a user enrollment into the preferred rewards program.

8. The apparatus of claim 1, wherein the status level is associated with a second benefit, wherein the second benefit includes a credit card rewards bonus, a money market savings booster, an investment account reward, a home loan credit, a priority service, banking cost benefits, or one or more additional accounts.

9. The apparatus of claim 1, wherein the apparatus determines a user eligibility based on the average asset balance, wherein the user eligibility comprises an eligibility for categorization of the user's financial institution account into the plurality of status levels.

10. The apparatus of claim 1, wherein the apparatus is further configured to:
receive the asset balance on the last day of a current month;
determine that the user's financial institution account is eligible for an up-tiering based on at least the asset balance, wherein the asset balance is greater than the asset balance required to remain categorized in the first status level, wherein up-tiering comprises changing the category of the user's financial institution account from a first level to a second status level, wherein the asset balance range associated with the second level is greater than the asset balance range associated with the first level;
determine an average asset balance based on generating an average monthly asset balance for at least two months prior to the current month;
categorize the user into the second status level based on at least the average asset balance; and
apply a second benefit associated with the second status level to the user's financial institution account.

11. The apparatus of claim 10, wherein determining that the user's financial institution account is eligible for an up-tiering based on at least the asset balance, wherein the asset balance is within the range of the first status level, and wherein the apparatus is further configured to:
receive the asset balance on the last day of a current month;
determine that the user's financial institution account is not eligible for an up-tiering based on at least the asset balance; and
maintain the categorization of the user's financial institution account in the first status level.

12. The apparatus of claim 1, wherein the apparatus is further configured to conduct an annual evaluation of the user's financial account categorization into the first status level, wherein the annual evaluation is based on an anniversary month, wherein the anniversary month is associated with the user enrollment into the preferred rewards program.

13. The apparatus of claim 1, wherein the apparatus is further configured to:
receive the asset balance during the annual evaluation;
determine that the asset balance is lower than the asset balance required to be categorized in the first status level; and
provide the user a grace period from the date of the annual evaluation to deposit additional funds and maintain the asset balance required to remain in the first status level.

14. The apparatus of claim 13, wherein the grace period is at least two months from the date of the annual evaluation.

15. The apparatus of claim 13, wherein the apparatus is configured to send a notification to the user to indicate that the asset balance is lower than the asset balance required to be categorized in the first status level before the annual evaluation, wherein the notification may be sent to the user in the form of a text message, a pop up message, or an email.

16. The apparatus of claim 13, wherein the apparatus is further configured to:
receive the asset balance at the end of the grace period provided;
determine an average asset balance based on generating an average monthly asset balance for at least two months prior to the current month;
determine that the user's financial institution account is eligible for down-tiering based on the average asset balance, wherein the average asset balance is lower than the asset balance required to remain categorized in the first status level, wherein down-tiering comprises changing the category of the user's financial institution account from a first status level to a third status level based on at least the average asset balance, wherein the asset balance range associated with the third status level is lower than the asset balance range associated with the first status level;
categorize the user into the third status level based on at least the average asset balance; and
apply a second benefit associated with the third status level to the user's financial institution account.

17. The apparatus of claim 13, wherein the apparatus is further configured to:
receive the asset balance at the end of the grace period provided;
determine an average asset balance by averaging the monthly asset balance for at least two months prior to the date of calculation of the average asset balance;
determine that the user's financial institution account is eligible to remain categorized in the first status level based on the average asset balance; and
maintain the categorization of the user's financial institution account in the first status level.

18. A method for identifying financial institution customers based on an asset balance structure using a computer program on a processor for a preferred rewards program, the method comprising:
receiving information associated with a user's financial institution account on the last day of a current month, wherein the information comprises a monthly asset balance;
determining an average asset balance based on generating an average monthly asset balance for at least two months prior to the current month;
categorizing the user, based on the average asset balance, to determine which of a plurality of status levels is applicable to the user, wherein the plurality of status levels is based on an asset balance range;
identifying an existing payment card associated with the user; and
applying a benefit associated with the categorized status level to the user's existing payment card.

19. A computer program product for identifying financial institution customers based on an asset balance structure for a preferred rewards program, the computer program product comprising a non-transitory computer-readable medium comprising code causing a first apparatus to:
receive information associated with a user's financial institution account on the last day of a current month, wherein the information comprises a monthly asset balance;
determine an average asset balance based on generating an average monthly asset balance for at least two months prior to the current month;
categorize the user, based on the average asset balance, to determine which of a plurality of status levels is applicable to the user, wherein the plurality of status levels is based on an asset balance range;
identify an existing payment card associated with the user; and
apply a benefit associated with the categorized status level to the user's existing payment card.
